(19) United States
(12) Patent Application Publication
(10) Pub. No.: US 2016/0291829 A1
(43) Pub. Date: Oct. 6, 2016

(54) MANAGEMENT OF DATA IN AN ELECTRONIC DEVICE

(71) Applicant: YOUR VOICE USA CORP., New York, NY (US)

(72) Inventors: Roberto Piroddi, Milan (IT); Paolo Siligoni, Milan (IT); Luca Agostini, Milan (IT)

(21) Appl. No.: 14/677,136

(22) Filed: Apr. 2, 2015

(51) Int. Cl. G06F 3/0488; G06F 3/0484; G06F 3/0486

(52) U.S. Cl. CPC G06F 3/0488; G06F 3/0486; G06F 3/04842

(57) ABSTRACT

An electronic device includes: a touch-screen display; a processing unit configured to: cooperate with said display for displaying in a first position on the display a first item associated to a first entity; cooperate with the display for displaying in a second position on the display a second item associated to a second entity; cooperate with the display to detect a drag gesture applied to the first item, the gesture defining on the display a trajectory which starts in the first position and ends in the second position; upon recognition of the gesture, triggering an operation, comprising at least one of: a transfer of information from a first memory area associated with the first entity to a memory area associated with the second entity; a command executed by an execution device, the execution device being associated with the second entity, the command being executed by the execution device as a function of data associated with the first item.

### BACKGROUND OF THE INVENTION

1. Field of the Invention

The present invention refers to the management of data in an electronic device.

2. State of the Art

As known, mobile phones, especially the so called smart phones, are provided with storage, processing and connection capabilities which allow the management of information/data by means of different channels and different technologies, involving different contacts, external devices, etc.

The Applicant has noted that currently no tools are available that permit management of data in an easy, reliable and intuitive way.

### SUMMARY OF THE INVENTION

It is an object of the present invention to provide an easy, user-friendly and reliable way to manage data available to an electronic device provided touch screen capabilities, and in particular by a smart phone or tablet.

Another object of the present invention is to provide a fancy and intuitive way to manage data available to an electronic device provided with touch screen capabilities, through which the user can easily handle data and/or connections.

### BRIEF DESCRIPTION OF THE DRAWINGS

These and other objects are substantially achieved by an electronic device according to the present invention. Further features and advantages will become more apparent from the detailed description of preferred and non exclusive embodiments of the invention. The description is provided hereinafter with reference to the attached drawings, which are presented by way of non limiting example, wherein:

FIG. 1 schematically shows a pictorial representation of an electronic device according to the present invention and a gesture performed thereon;

FIGS. 2a-2e show block diagrams of possible embodiments of the invention;

FIGS. 3 to 6 schematically show possible embodiments of the invention;

FIG. 7 schematically shows data used in the invention.

### DETAILED DESCRIPTION OF THE INVENTION

In the accompanying drawings reference numeral 1 indicates an electronic device according to the present invention. The electronic device 1 is preferably a portable or mobile device. For example the electronic device 1 can be a mobile phone, and in particular a so-called smart phone, or a tablet. The electronic device 1 comprises a touch-screen display 10.

By means of the touch-screen capabilities of display 10 the device 1 is able to detect the position in which a user touches the display and the possible trajectory designed by the user moving his/her finger while it is in contact with the surface of the display. Of course parts of the body other than fingers can be used, although fingers are the most commonly employed. This technology is per se well known and will not be disclosed in further detail.

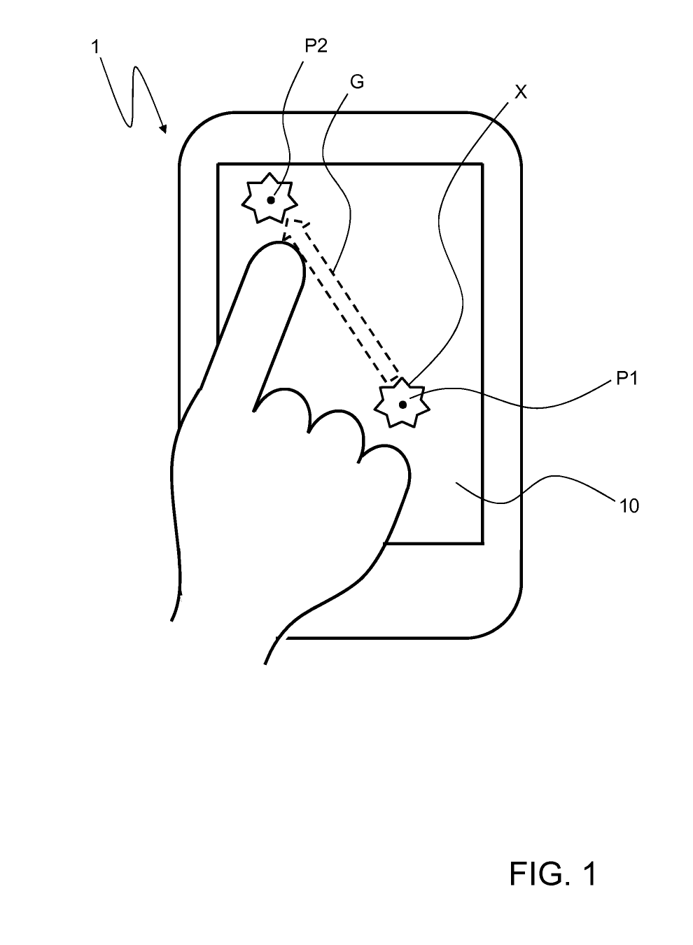

The electronic device 1 comprises a processing unit 30. Preferably the processing unit 30 manages the overall functioning of the electronic device 1. The processing unit 30 cooperates with the touch-screen display 10 for displaying in a first position P1 on said display 10 a first item X associated with a first entity E1 (FIG. 1). For example the first item X can be an icon, a sign, a graphic symbol, a group of characters which is/are associated to the first entity E1 so that the user, when looking at the first item X, recalls the first entity E1.

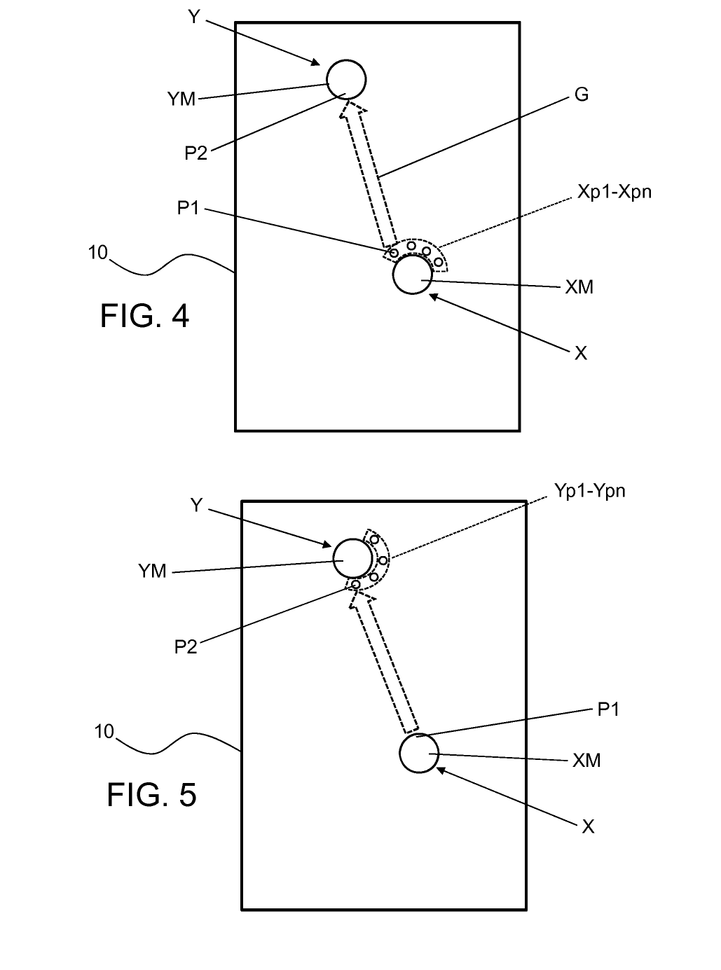

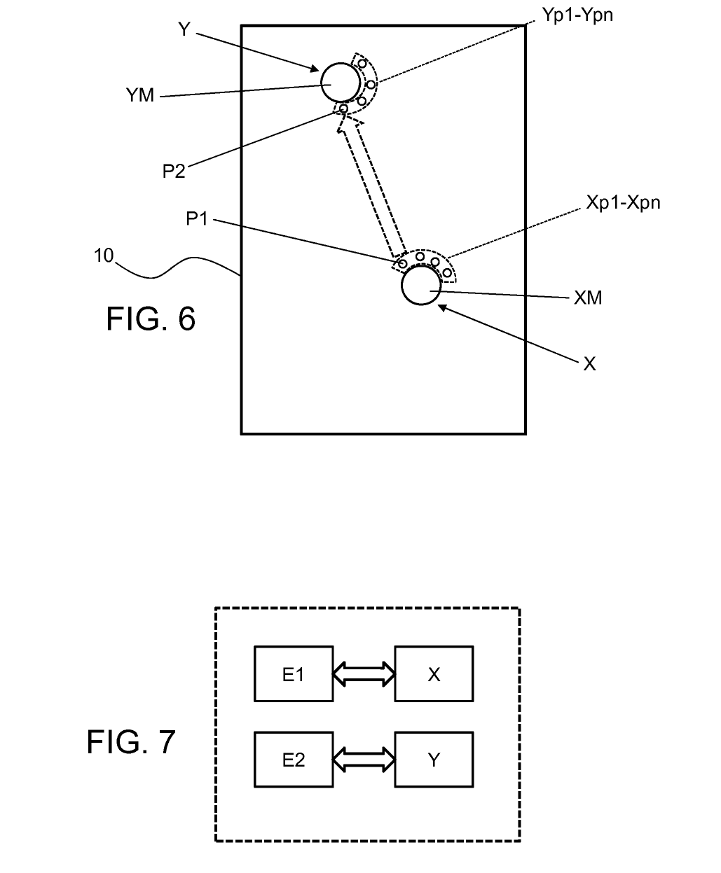

The first entity E1 can be, for example, a person or an apparatus. The first entity E1 can also be a file, a set of data, or any other item available to or accessible by said device 1. In a preferred embodiment, the first entity E1 is or is associated to the user of the device 1. Preferably, the first item X comprises one main portion XM and one or more peripheral portions Xp1-Xpn (FIGS. 3-6). The main portion XM is representative of the first entity E1. For example, if the first entity E1 is the user, the main portion XM can be an avatar which pictorially represents the user, or an image chosen by the user to represent him/her-self. The peripheral portions Xp1-Xpn (FIGS. 4, 6) represent data associated with the first entity E1. For example, if the first entity is the user, the peripheral portions Xp1-Xpn can directly or indirectly represent personal data, positional data, biometric data (made available by a biometric device connected with the device 1, for example by means of a Bluetooth® connection), etc.

Preferably the peripheral portions Xp1-Xpn can also represent actions/commands associated with the first entity E1. Preferably not all the possible peripheral portions Xp1-Xpn are always shown around the main portion XM. For example, the peripheral portions Xp1-Xpn to be always present can be selected by the user in a suitable set up menu or page. Preferably the peripheral portions Xp1-Xpn can be divided into two groups:
a first group indicative of data that can be provided as “output” or as a bases for operations to be performed;
a second group indicative of actions/operations that can be performed by the electronic device 1 and/or a device other than the electronic device 1.

The processing unit 30 cooperates with the touch-screen display 10 for displaying in a second position P2 on said display 10 a second item Y representative of a second entity E2 (FIG. 1). For example the second item Y can be an icon, a sign, a graphic symbol, a group of characters which is/are associated to the second entity E2 so that the user, when looking at the second item Y, recalls the second entity E2. The second entity E2 can be a person or an apparatus. In a preferred embodiment, the second entity E2 is a person or apparatus that the user of the device 1 wishes to involve in an operation. Preferably, the second item Y comprises one main portion YM and one or more peripheral portions Yp1-Ypn (FIGS. 3-6).

The main portion YM is representative of the second entity E2. For example, if the second entity E2 is a person whose data are stored in the address book of the device 1, the main portion YM can be an avatar which pictorially represents this person, or an image chosen by this person to represent him/her-self. In another example, the second entity can be a device or a software program, that the user wishes to involve in the operation to be carried out. The peripheral portions Yp1-Ypn (FIGS. 5-6) represent operations associated with the second entity E2. For example, if the second entity is the aforesaid person, the peripheral portions Yp1-Ypn can represent communication channels available to reach this individual (the operation being the transmission of data), devices or software tools available to this individual (the operation being the activation of said devices or software tools), etc.

In case the second entity E2 is a device or software program, the peripheral portions Yp1-Ypn can be indicative of actions/commands that can be executed by or with the help of such device/software program. Preferably not all the possible peripheral portions Yp1-Ypn are always shown around the main portion YM. For example, the peripheral portions Yp1-Ypn to be always present can be selected by the user in a suitable set up menu or page.

Preferably the peripheral portions Yp1-Ypn can be divided into two groups:
a first group indicative of data that can be provided as “output” or as a bases for operations to be performed;
a second group indicative of actions/operations that can be performed.

FIG. 7 show the logic connection between entities E1, E2 and the respective graphical representations provided by items X, Y. This logic connection is stored in a suitable memory area associated to the processing unit 30. The processing unit 30 is also configured to cooperate with the display 10 to detect a drag gesture G applied to the first item X. The drag gesture G is applied by the user, for example by means of one of his/her fingers. Of course also other parts of the body can be used. However, the most practical and simple is the use of a finger. The drag gesture G is recognized by the processing unit 30 cooperating with the touch-screen capabilities of the display 10. The drag gesture G defines, on the display 10, a trajectory which starts in the first position P1, i.e., the position of the first item X, and ends in the second position P2, i.e., the position of the second item Y. This means that the user touches the screen at the first position P1 and, keeping the finger (or, in general, the involved part of his/her body) in contact with the display, moves said finger on the display, i.e., the user changes in time the position in which he/she is touching the screen, until the second position P2 is reached.

In practical terms the trajectory of the drag gesture G is defined by the substantially continuous sequence of positions in which, in time, the finger of the user contacts the touch-screen display 10 starting from the first position P1 and ending in the second position P2. Preferably the processing unit 30 is configured to cooperate with the display 10 graphically represent the displacement of a replica of the first item X (or a portion thereof) from the first position P1 along the trajectory defined by the drag gesture G while the same gesture G is executed, so as to give the pictorial impression that the first item X (or a portion thereof) directly follows the displacement imparted by the user, as if it were dragged by the user's finger. Upon recognition of the gesture G, i.e., when the trajectory reaches the second position P2, the processing unit 30 is configured to trigger an operation.

According to the invention, the operation comprises at least one of:
a transfer of information from a first memory area associated with said first entity E1 to a second memory area associated with said second entity E2;
a command executed by an execution device, said execution device being associated with said second entity E2; such command is executed based on data D associated with the first entity E1.

It is to be noted that, from a general point of view, the term “command” used herein designates any action or operation that can be performed by the execution device upon reception of a suitable instruction. In one embodiment, the first memory area is embedded in the electronic device 1. As an alternative, the first memory area is located outside the electronic device 1 and is connected to the electronic device 1 by means of a wireless and/or remote connection. For example, the first memory area can be embedded in a server apparatus, remotely connected to the electronic device 1. In one embodiment, the second memory area is embedded in the electronic device 1. As an alternative, the second memory area is located outside the electronic device 1 and is connected to the electronic device 1 by means of a wireless and/or remote connection. For example, the second memory area can be embedded in a server apparatus, remotely connected to the electronic device 1.

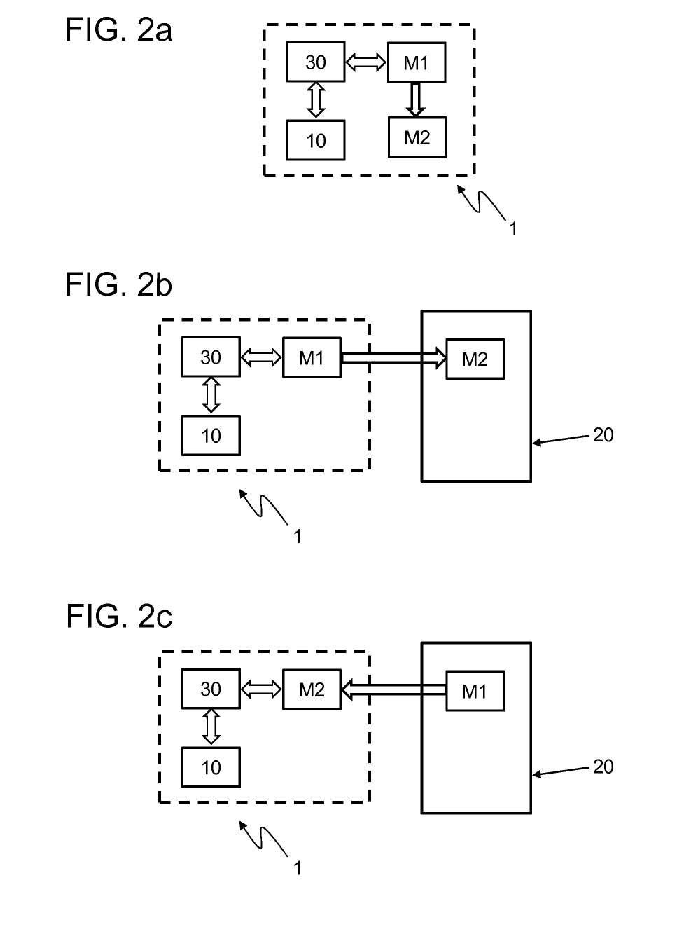

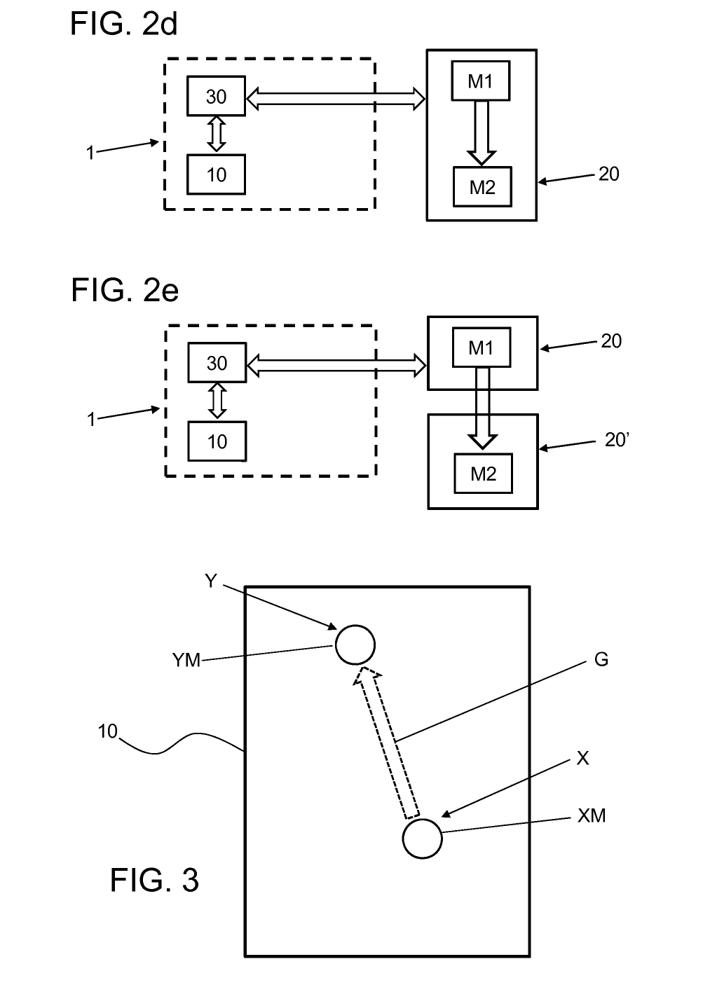

In view of the above, the transfer of information can be carried out according to four different schemes:
a) from a memory area (first memory area M1) embedded in the electronic device 1 to a memory area (second memory area M2) embedded in the same electronic device 1 (FIG. 2a);
b) from a memory area (first memory area M1) embedded in the electronic device 1 to a memory area (second memory area M2) which is located outside the electronic device 1, for example a memory area of a remote server or a remote device 20 (FIG. 2b);
c) from a memory area (first memory area M1) which is located outside the electronic device 1, for example a memory area of a remote server or a remote device 20 to a memory area (second memory area M2) embedded in the electronic device 1 (FIG. 2c);
d) from a memory area (first memory area M1) which is located outside the electronic device 1, for example a memory area of a remote server or a remote device, to a memory area (second memory area M2) which is located outside the electronic device 1, for example a memory area of a remote server or a remote device. In this case, the first and second memory areas M1, M2 can be included in the same apparatus 20 (FIG. 2d), or can be included in distinct apparatuses 20, 20′ (FIG. 2e).

It is to be noted that the mentioned memory areas can be any type of physical or virtual memory associated with respective device or apparatus. In one embodiment, the execution device and the electronic device 1 are the same device. This means that the command triggered by the drag gesture is executed by the same electronic device 1. As an alternative, the execution device can be an apparatus other than the electronic device 1. This means that the drag gesture triggers the transmission to the execution device of a suitable instruction signal so as to have the latter execute the desired command.

As mentioned above, the first entity E1 can be either a person or a device; the second entity E2 can be either a person or a device. Accordingly, the communication between the first and second entities E1, E2 can occur in one of the following scenarios:
a) from person to person
b) from person to device;
c) from device to person;
d) from device to device.

Preferably the operation that is executed is independent from a distance between the first position P1 and the second position P2. In other terms, the operation is determined based on the second entity E2, possibly on the operation represented by the peripheral portions Yp1-Ypn of the second item Y, possibly on the data D, but not on the distance between the first and second positions P1, P2 or the distance travelled by the drag gesture G trajectory. In an embodiment, the first position P1 corresponds to the position of one peripheral portion Xp1-Xpn of the first item X. In this case, the triggered operation is executed on the data represented by such peripheral portion. In an embodiment, the second position corresponds to the position of one peripheral portion Yp1-Ypn of the second item Y. In this case, the operation that is triggered is the operation associated with or represented by such peripheral portion. Thus the trajectory of the drag gesture G, depending on the data and/or operation of interest, can be arranged in one of the following ways:
1) starting point: main portion XM of the first item X; end point: main portion YM of the second item Y;
2) starting point: one peripheral portion Xp1-Xpn of the first item X; end point: main portion YM of the second item;
3) starting point: main portion XM of the first item X; end point: one peripheral portion Yp1-Ypn of the second item Y;
4) starting point: one peripheral portion Xp1-Xpn of the first item X; end point: one peripheral portion Yp1-Ypn of the second item Y.

It has to be noted that the peripheral portions Xp1-Xpn of the first item X and/or the peripheral portions Yp1-Ypn of the second item Y are not necessarily shown; accordingly, the first item X can coincide with the main portion XM and the second item Y can coincide with the main portion YM. It is to be noted that the information/data transferred from the first entity E1 to the second entity E2 can comprise any type of information/data in electronic format, such as for example documents (editable/non-editable), audio/video files, images, pieces of software, email messages, chat messages, attachments, etc. Regarding the transfer of information from a first memory area associated with the first entity E1 to the second memory area associated with the second entity E2, the following example can be considered. The user of the electronic device 1 (the user being the first entity E1) wishes to notify a friend (second entity E2) of his/her geographical position, the latter being known to the processing unit 30 due to GPS (Global Positioning System) technology embedded in the device 1.

Accordingly, the user can be represented on the display 10 as the main portion XM of the first item X, and the geographical position can be represented by a peripheral portion Xp1-Xpn of the same first item X. The user's friend is represented by the main portion YM of the second item Y, without peripheral portions. In a possible embodiment, the user draws a drag gesture on the display wherein the first position P1 is the position on the display 10 of the peripheral portion Xp1-Xpn representing the geographical position of the user, and the second position P2 is the position on the display 10 of the second item Y. Accordingly, the geographical position will be transmitted by a default communication channel (e.g., an SMS message, a chat message, etc.); as an alternative, the user is prompted to select the desired communication channel from a suitably shown menu. In an embodiment, the second item Y includes both the main portion YM and the peripheral portions Yp1-Ypn. Two or more of the peripheral portions Yp1-Ypn represent different communication channels. Accordingly, the user will draw a drag gesture on the display 10 wherein the first position P1 is the position on the display 10 of the peripheral portion Xp1-Xpn representing the geographical position of the user, and the second position P2 is the position on the display 10 of the peripheral portion Yp1-Ypn that represents the communication channel to be used. In other words, the user selects the desired communication channel by dragging the geographical position icon (peripheral portion Xp1-Xpn) over the symbol of the second item Y (peripheral portion Yp1-Ypn) representing such communication channel.

In the above example, the first memory area is embedded in the electronic device 1, and corresponds to that memory area in which the GPS position is stored; the second memory area is embedded in a device belonging to the user's friend (second entity E2), and corresponds to that memory area in which the GPS position is stored when received. Preferably the processing unit 30 is configured to process said data D depending on the second item Y before said operation is executed. In other terms, once the data D and the second item Y are identified by the drag gesture, the processing unit 30 can modify the data D. In particular such modification is aimed at preparing the data D to the operation that has to be carried out. In addition or as an alternative, the processing unit 30 is configured to transmit to a remote apparatus information identifying the data D and information indicative of the operation to be executed. This processing is advantageously performed before the operation is executed. Accordingly the remote apparatus can process the data D in order to prepare the same to the operation. In a possible embodiment the processing unit 30 directly transmits the data D to the remote apparatus; in a different embodiment, the processing unit 30 provides the remote apparatus with indication that allow retrieving the data D (e.g., a link, a telematic address, etc.). Preferably, this modifications carried out by the processing unit 30 and/or by said remote apparatus do not substantially change the content of the data D. For example, the processing can attain the format, the size, the resolution, etc. of the data D, in order to facilitate the execution of the operation.

Preferably, a two step processing can be performed on the data D:
a first processing step, wherein the format of the data is somehow changed;

a second processing step, regarding the way in which the data D are used to perform the operation.

Considering again the above example, in which the user of the device 1 wishes to share some biometric values with a friend of his/her, the first processing step can be carried out in order to convert the original data, which are in a proprietary format imposed by the biometric device, into a more common and non-proprietary format. The second processing step can be performed when those data, transmitted from the device 1 to the addressee, are presented on the display of the addressee device, in a fancy and/or pictorial way. The creation of this fancy and/or pictorial representation is the second processing step. In another example, the first item X (or one of its peripheral portions Xp1-Xpn) can be representative of an action/command to be executed by the execution device. For example, the execution device can be a device other than the electronic device 1. In this case, the used draws the drag gesture G from the first item X (or portion thereof) to the item Y, that represents the execution device. For example, the action/command is an activation command. Accordingly, when the drag gesture G reaches the second item Y, an activation signal will be sent to the execution apparatus in order to activate the same. The invention achieves important advantages. Firstly the invention provides an easy, user-friendly and reliable way to manage data, information processing and exchange in an electronic device provided with touch-screen capabilities, and in particular in a smart phone or tablet. Furthermore, the invention provides a fancy and intuitive way to manage data accessible by an electronic device provided with touch screen capabilities, through which the user can easily handle large amounts of data.

What is claimed is:

1. An electronic device comprising:
a touch-screen display
a processing unit configured to:
cooperate with said touch screen display for displaying in a first position on said display a first item associated to a first entity;
cooperate with said touch screen display for displaying in a second position on said display a second item associated to a second entity;
cooperate with said touch-screen display to detect a drag gesture applied to said first item by a user, said gesture defining on said touch-screen display a trajectory which starts in said first position and ends in said second position;
upon recognition of said gesture, triggering an operation, wherein said operation comprises at least one of:
a transfer of information from a first memory area associated with said first entity to a second memory area associated with said second entity;
a command executed by an execution device, said execution device being associated with said second entity, said command being executed by said execution device as a function of data associated with said first item.

2. The electronic device according to claim 1 wherein said data identify a type of command to be executed by said execution device.

3. The electronic device according to claim 1 wherein said data identify data on which said command is executed.

4. The electronic device according to claim 1 wherein said operation is independent from a distance between said first item and said second item on said display.

5. The electronic device according to claim 1 wherein a default channel is set for said transmission.

6. The electronic device according to claim 1 wherein said processing unit is configured to cooperate with said touch screen display to prompt a user to select a communication channel for said transmission.

7. The electronic device according to claim 1 wherein said processing unit is configured to process said data depending on said second entity before said operation is executed.

8. The electronic device according to claim 1 wherein said processing unit is configured to transmit to a remote apparatus information identifying said data and information indicative of the operation to be executed.

9. The electronic device according to claim 1 wherein said first item comprises one main portion and one or more peripheral portions, said main portion representing said first entity, said one or more peripheral portions representing data associated with said first entity.

10. The electronic device according to claim 9 wherein said first position corresponds to one of said one or more peripheral portions.

11. The electronic device according to claim 1 wherein said second item comprises one main portion and one or more peripheral portions, said main portion representing said second entity, said peripheral portions representing operations associated with said second entity.

12. The electronic device according to claim 10 wherein said second position corresponds to one of said one or more peripheral portions.

13. A method comprising:
displaying in a first position on a touch-screen display a first item associated to a first entity;
displaying in a second position on said display touch-screen a second item associated to a second entity;
detecting a drag gesture applied to said first item by a user, said gesture defining on said touch-screen display a trajectory which starts in said first position and ends in said second position;
upon recognition of said gesture, triggering an operation,
wherein said operation comprises at least one of:
a transfer of information from a first memory area associated with said first entity to a second memory area associated with said second entity;
a command executed by an execution device, said execution device being associated with said second entity, said command being executed by said execution device as a function of data associated with said first item.

14. A non-transitory computer readable storage medium storing one or more programs comprising instructions, which when executed by an electronic device cause the device to:
display in a first position on a touch-screen display a first item associated to a first entity;
display in a second position on said display touch-screen a second item associated to a second entity;
detect a drag gesture applied to said first item by a user, said gesture defining on said touch-screen display a trajectory which starts in said first position and ends in said second position;
upon recognition of said gesture, trigger an operation,
wherein said operation comprises at least one of:
a transfer of information from a first memory area associated with said first entity to a second memory area associated with said second entity;
a command executed by an execution device, said execution device being associated with said second entity, said command being executed by said execution device as a function of data associated with said first item.
